(19) United States
(12) Patent Application Publication
(10) Pub. No.: US 2018/0284395 A1
(43) Pub. Date: Oct. 4, 2018

(54) PROJECTION SYSTEM WITH SINGLE FRONT LENS

(71) Applicant: QISDA CORPORATION, Taoyuan City (TW)

(72) Inventors: Chih-Shiung Chien, Taoyuan City (TW); Ming-Kuen Lin, Taoyuan City (TW)

(21) Appl. No.: 15/935,066

(22) Filed: Mar. 26, 2018

(30) Foreign Application Priority Data
Mar. 30, 2017 (CN) 201710203638.9

(51) Int. Cl. G02B 13/00; G03B 21/00; G03B 21/20

(52) U.S. Cl. CPC G02B 13/0065; G03B 21/2066; G03B 21/008

(57) ABSTRACT

A projection system is provided in the invention having a biaxially-tilted digital micro mirror device (DMD) that can facilitate component and light path configuration in space and avoid included angles between the prism and the DMD. Additionally, with the specially designed illuminating unit, only one aspheric lens is implemented in the front lens set and only one lens is implemented in the rear lens set and the projection system is still performance proved with reduced overall size.

### BACKGROUND OF THE INVENTION

### 1. Field of the Invention

The invention relates to a projection system, and more particularly, to a projection system with a biaxially-tilted digital micro mirror device (DMD).

### 2. Description of the Prior Art

Supplying with enough illumination, a projector utilizes principles of imaging to project tiny image to a huge screen through a digital micro mirror device (DMD) to share information.

A projector of prior art includes an uniaxial DMD, a prism set with total internal reflection (TIR), a reflecting mirror, a lens set modules, and a light pipe. The light passing through the light pipe and the lens set module will be reflected by the reflecting mirror to the TIR prism set and then transmitted by the uniaxial DMD to the imaging lens as an imaging light projected on the screen. However, due to the restrictions imposed by the physical characteristics of the uniaxially-tilted DMD that only accepts light incident with an inclining angle, the TIR prism set is required to be setup with an inclined angle (such as 45 degree) relative to the DMD, which is unfavorable to size reduction. In today's trend of projector size minimization, the above restriction is unfavorable to the usage convenience and product competitiveness. Therefore, it is important to develop a projector with smaller size.

### SUMMARY OF THE INVENTION

To solve the above problem, the embodiment of the invention provides a projection system with single front lens which includes a light source module, a first lens set, a second lens set, a prism set, a biaxially-tilted digital micro mirror device (DMD), and an imaging lens. The light source module emits an incident light. The biaxially-tilted DMD receives and converts the incident light into an imaging light. The prism set is disposed between the light module and the biaxially-tilted DMD. The first lens set consists of an aspheric lens is disposed between the light source module and the prism set and is closer to the light source module. The second lens set consists of a lens is disposed between the first lens set and the prism set for transmitting the incident light from the first lens set. The imaging lens receives and projects the imaging light.

In the projection system provided by the invention, a refractive index for the aspheric lens of the first lens set is greater than or equal to 1.67.

In the projection system provided by the invention, a ratio of a rear effective focal length for the second lens set to a front effective focal length for the first lens set is greater than or equal to 1.8 and less than or equal to 2.1.

In the projection system provided by the invention, a distance between the first lens set and the second lens set is greater than or equal to 10 mm and less than or equal to 19 mm.

In the projection system provided by the invention, the second lens set consists of an aspheric lens with a refractive index greater than or equal to 1.48 and less than or equal to 1.75.

In the projection system provided by the invention, the second lens set consists of a spherical lens with a refractive index greater than or equal to 1.75.

In the projection system provided by the invention, the prism set includes a first prism and a second prism. The first prism includes a first surface and a second surface neighboring the first surface, where the incident light sequentially passes through the first surface and the second surface. The second prism is disposed between the first prism and the biaxially-tilted DMD and includes a third surface, a fourth surface, and a fifth surface, where the third surface neighbors the fourth surface and the fifth surface, the fourth surface faces the biaxially-tilted DMD, the incident light sequentially passes through the third surface and the fourth surface to the biaxially-tilted DMD and is converted into the imaging light, and the imaging light sequentially passes through the fourth surface and is reflected at the third surface and passes through the fifth surface to the imaging lens. The second lens set stacks with the first prism.

In the projection system provided by the invention, the biaxially-tilted DMD device is in the form of a first rectangle including two opposite first long sides and two opposite first short sides, and the fourth surface of the second prism is in the form of a second rectangle including two opposite second long sides parallel to the first long sides and two opposite second short sides parallel to the first short sides.

In the projection system provided by the invention, the first lens set is disposed between the first prism and the light source module, the second lens set is disposed between the first lens set and the first prism, and the imaging lens faces the fifth surface of the second prism.

In the projection system provided by the invention, a refractive index of the first prism is less than a refractive index of the second prism.

In the projection system provided by the invention, the second prim is an isosceles right triangle prism whose refractive index is greater than or equal to 1.6.

In the projection system provided by the invention, a reflecting module and a shading component are also included. The reflection module is disposed between the first lens set and the second lens set for reflecting the incident light from the first lens set to the second lens set. The shading component is disposed between the first lens set and the reflecting module.

In the projection system provided by the invention, the projection system is a telecentric projection system.

The objective of the invention is to provide a projection system whose height and whose overall size are effectively reduced through the improved component configuration and light path design.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a component structure view of an embodiment of the projection system with single front lens of the invention.

FIG. 2 is a schematic diagram showing a partially enlarged view of the component configuration of the projection system shown in FIG. 1.

FIG. 3 is a schematic diagram showing a top view of the component configuration of the projection system shown in FIG. 1.

### DETAILED DESCRIPTION

Certain terms are used throughout the following description and claims to refer to particular system components. As one skilled in the art will appreciate, manufacturers may refer to a component by different names. In the following discussion and claims, the system components are differentiated not by their names but by their function and structure differences. In the following discussion and claims, the terms “include” and “comprise” are used in an open-ended fashion and should be interpreted as “include but is not limited to”. Also, the term “couple” or “link” is intended to mean either an indirect or a direct mechanical or electrical connection. Thus, if a first device is coupled or linked to a second device, that connection may be through a direct mechanical or electrical connection, or through an indirect mechanical or electrical connection via other devices and connections.

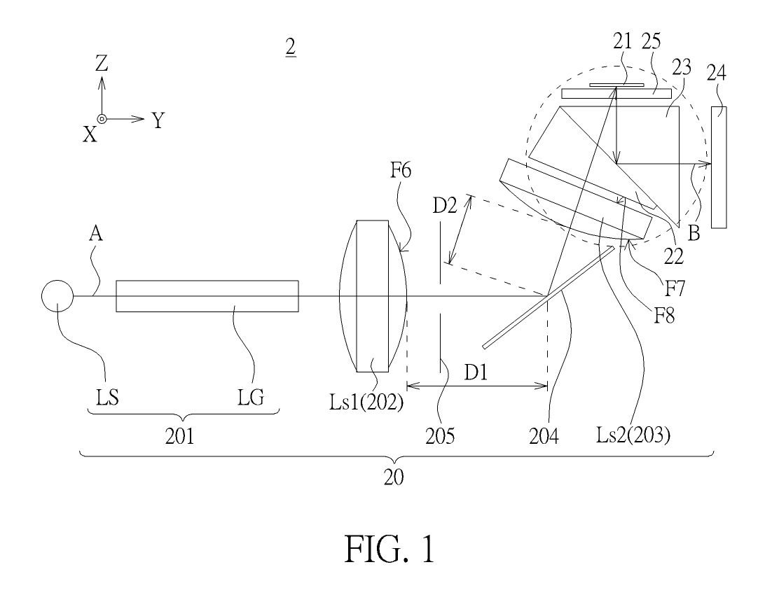

Please refer to FIG. 1. FIG. 1 is a schematic diagram showing a component configuration of a projection system with single front lens in an embodiment of the invention. The projection system 2 is a telecentric projection system including a light source module 201, a first lens set 202, a second lens set 203, a prism set, a biaxially-tilted digital micro mirror device (DMD) 21, and an imaging lens 24. The light source module 201, the first lens set 202, and the second lens set 203 compose an illuminating unit 20 of the projection system 2 for emitting an incident light A. The biaxially-tilted DMD 21 is covered with a cover glass 25 and used to receive the incident light A emitted from the illuminating unit 20 and convert the incident light A into an imaging light B. It should be noted that the biaxially-tilted DMD 21 is a TRP (Tilt & Roll Pixel) DLP® Pico™ chipset of TEXAS INSTRUMENTS Inc., which includes multiple micro mirrors, not shown in FIG. 1, for reflecting the incident light A into the imaging light B.

The prism set includes a first prism 22 and a second prism 23, which are disposed between the light source module 201 and the biaxially-tilted DMD 21. The first lens set 202 is disposed between the first prism 22 and the light source module 201 and closer to the light source module 201. The second lens set 203 is disposed between the first lens set 202 and the first prism 22. The light source module 201 includes a light source LS for emitting the incident light A and a light guide LG disposed between the light source LS and the first lens set 202. The light guide LG, the first lens set 202, and the second lens set 203 are utilized for transmitting the incident light A emitted from the light source LS, where a physical characteristic of focus possessed by the first lens set 202 and the second lens set 203 assists in converging and accurately projecting the incident light A to the biaxially-tilted DMD 21. The illuminating unit 20 in the embodiment may also include a reflecting module 204 disposed between the first lens set 202 and the second lens set 203 for reflecting the incident light A from the first lens set 202 to the second lens set 203. Additionally, a shading component 205 may be disposed between the first lens set 202 and the reflecting module 204. When the first lens set 202 focuses the incident light A towards the reflecting module 204, the shading component 205 is situated halfway to block unnecessary light from entering the imaging lens 24 and thereby enhancing the image quality. Please be noted that the implementation of the reflecting module 204 and the shading component 205 is only an embodiment, which poses no limit to the projection system 2 in the invention. In other embodiments, the reflecting module 204 and the shading component 205 may be removed from the projection system 2 according to usage need.

The projection system 2 provides a structure of further minimization of the number of components and the overall size of the projection system 2 while a certain imaging performance is maintained by adopting the first lens set 202 (or the front lens set of the illuminating unit 20) with only one first lens Ls1 and the second lens set 203 (or the rear lens set of the illuminating unit 20) with only one second lens Ls2. That is, the illuminating unit 20 is equipped with only two lenses to converge and project the incident light A to the biaxially-tilted DMD 21, which further reduces the length of the projection system 2. The first lens Ls1 is positioned between the light guide LG of the light source module 201 and the reflecting module 204. The second lens Ls2 is positioned between the reflecting module 204 and the first prism 22. Specifically, the first lens Ls1 is exemplified by an aspheric lens, and the second lens Ls2 is exemplified by an aspheric lens or a spherical lens. As the single aspheric lens with such a high refractive index greater than or equal to 1.67 exemplifies the first lens Ls1, image distortion and optical aberration are kept minor. As the single aspheric lens with such a low refractive index greater than or equal to 1.48 and less than or equal to 1.75, or as the single spherical lens with such a high refractive index greater than or equal to 1.75, exemplifies the second lens Ls2, image distortion is kept minor and correction for optical aberration is achieved.

In the embodiment of the invention, the first lens Ls1 includes a light emitting surface F6 facing the reflecting module 204 with a first distance D1 therebetween and the second lens Ls2 includes a light incident surface F7 facing the reflecting module 204 with a second distance D2 therebetween. A sum of the first distance D1 and the second distance D2, or a distance between the first lens set 202 and the second lens set 203, is greater than or equal to 10 mm and less than or equal to 19 mm. Moreover, a ratio of a rear effective focal length for the second lens set 203 to a front effective focal length for the first lens set 202 is greater than or equal to 1.8 and less than or equal to 2.1. That is, a magnification resulted from the first lens set 202 and the second lens set 203 equals the value of the ratio, and the value also represents a ratio of an effective area of the biaxially-tilted DMD 21 (or total area of the micro mirrors) to an area of a light emitting end of the light guide LG. Accordingly, if the ratio of effective focal length between the rear lens and the front lens is greater than the upper bound mentioned above as 2.1, it is derived that the area of the light emitting end of the light guide LG is too small and the amount of light out of the light guide LG is deficient, giving rise to darker projection. If the ratio is smaller than the lower bound mentioned above as 1.8, it is derived that the area of the light emitting end of the light guide LG is too large, a light spot area formed after the incident light A passing through the first lens set 202 and the second lens set 203 overfills the effective area of the biaxially-tilted DMD 21 (or the total area of the micro mirrors), and an overfill loss (or excessive incident light A) is too much, giving rise to stray light in the illuminating unit 20 which affects contrast in the projected image. After the above improvement for the first lens set 202 and the second lens set 203, the number of components and the overall size of the projection system 2 are further minimized without having the light path interfered by any structure in the projection system 2. As for the projection system equipped with a much advanced 0.37-inch (or smaller) biaxially-tilted DMD 21, the optical performance derived thereby is almost identical to a system with two (or more) lenses in the first lens set 202.

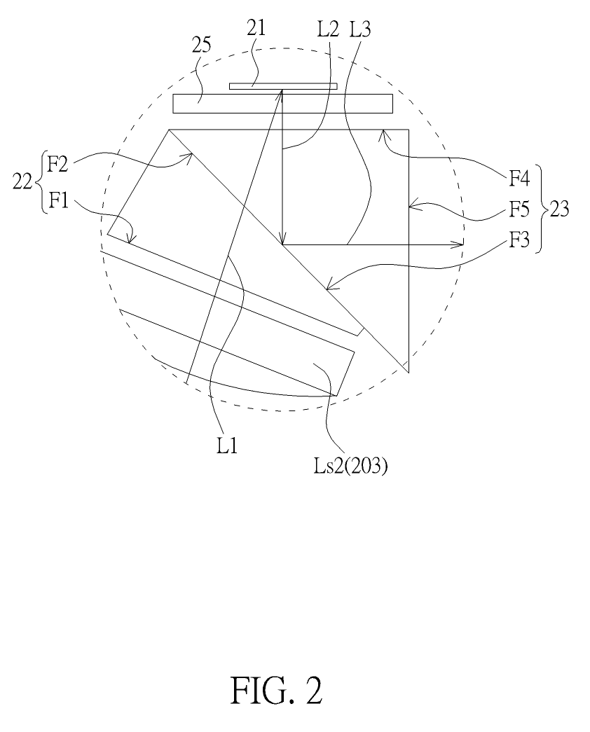

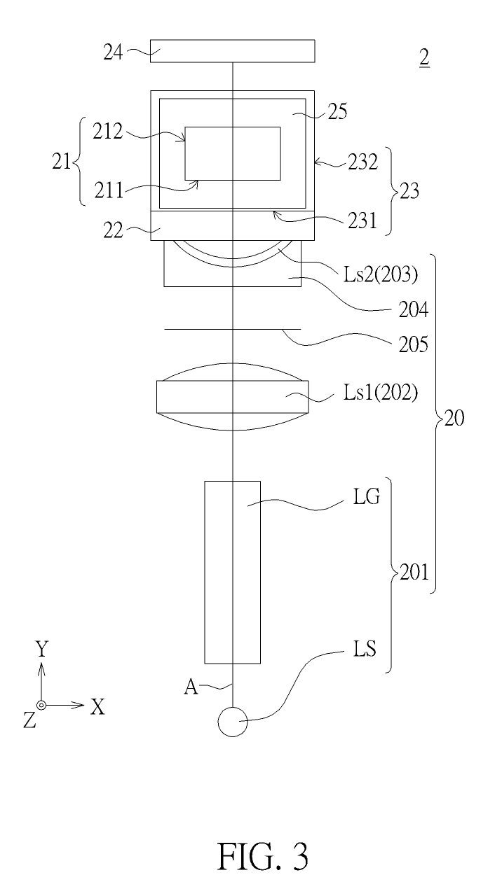

Please refer to FIG. 1 to FIG. 3. FIG. 2 is a schematic diagram showing a partially enlarged view of the component configuration of the projection system shown in FIG. 1. FIG. 3 is a schematic diagram showing a top view of the component configuration of the projection system shown in FIG. 1. As shown in FIG. 1 to FIG. 3, the biaxially-tilted DMD 21 is exemplified as a plane device in the form of a first rectangle including two opposite first long sides 211 and two opposite first short sides 212. Specifically multiple micro mirrors (not shown in the figures) of the biaxially-tilted DMD 21 may tilt between two statuses of ON and OFF. As the micro mirrors are configured to the ON status, they tilt for a first angle (such as 12 degree) along each of diagonals successively, which is equivalent to tilting for a second angle (such as 17 degree) against an orientation along the first long side 211 (X-axis orientation), thereby reflecting the incident light A with a third angle (about 34˜36 degree) into the imaging light B. The first prism 22 disposed between the illuminating unit 20 and the biaxially-tilted DMD 21 includes a first surface F1 and a second surface F2 neighboring the first surface F1. The second prism 23 disposed between the first prism 22 and the biaxially-tilted DMD 21 includes a third surface F3, a fourth surface F4, and a fifth surface F5, where the third surface F3 neighbors the fourth surface F4 and the fifth surface F5, the fourth surface F4 faces the biaxially-tilted DMD 21, and the fifth surface F5 faces the imaging lens 24. The fourth surface F4 of the second prism 23 may be shaped in the form of a second rectangle including two opposite second long sides 231 and two opposite second short sides 232, where the two second long sides 231 are parallel to the two first long sides 211 of the biaxially-tilted DMD 21 and the two second short sides 232 are parallel to the two first short sides 212 of the biaxially-tilted DMD 21. The second prism 23 may be selected as, but not limited to, an isosceles right triangle prism in the embodiment of the invention. The imaging lens 24 that faces the fifth surface F5 of the second prism 23 receives and projects the imaging light B.

In the embodiment of the invention, an included gap lies between the first surface F1 of the first prism 22 and a light emitting surface F8 of the second lens Ls2, where the light emitting surface F8 faces the first prism 22. However, the configuration is not limited thereof. In other embodiments, the light emitting surface F8 of the second lens Ls2 may stack with the first surface F1 of the first prism 22 via adhesion or other ways of attachment to further reduce the overall height of the system for the purpose of slimming the projection system 2. Also, in the embodiment, the second surface F2 of the first prism 22 is in contact with the third surface F3 of the second prism 23, and a refractive index of the first prism 22 is smaller than that of the second prism 23. Specifically, the refractive index of the first prism 22 is preferably about 1.51633 and the refractive index of the second prism 23 is greater than or equal to 1.6 (preferably 1.666718) to ensure total internal reflection of the imaging light B at the third surface F3, and this configuration poses no limit to the embodiments. Additionally, material of the first prism 22 may preferably be selected as a glass of model S-BSL7 produced by OHARA Inc., and material of the second prism 23 may preferably be selected as a glass of model S-BAH11 produced by OHARA Inc., but the selection poses no limit to the embodiments. In other embodiments of the invention, an air medium may lie between the second surface F2 of the first prism 22 and the third surface F3 of the second prism 23, which means there is gap between the second surface F2 of the first prism 22 and the third surface F3 of the second prism 23, rendering the refractive index between the first prism 22 and the second prism 23 in no need of consideration.

Further detail of how the incident light A and the imaging light B travel in the projection system 2 of the invention is described as followed. As shown in FIG. 1 and FIG. 2, the incident light A is emitted from the light source LS and then received by the light guide LG, where the light guide LG may be shaped as a wedge whose light incident area for receiving the incident light A is greater than the light emitting area for emitting the incident light A so that coupling efficiency may be promoted effectively. When the incident light A has sequentially passed through the light guide LG, the first lens Ls1, the shading component 205, the reflecting module 204, and the second lens Ls2, the incident light A perpendicularly enters the first surface F1 of the first prism 22, that is, the incident orientation is parallel to a normal vector of the first surface F1. The incident light A proceeds in the first prism 22 along a light path L1 and sequentially passes through the second surface F2 of the first prism 22 and the third surface F3 and the fourth surface F4 of the second prism 23 to reach and be reflected by the biaxially-tilted DMD 21 into the imaging light B. Specifically, the biaxially-tilted DMD 21 has its first long sides 211 and first short sides 212 oriented along X-axis and Y-axis respectively, and the fourth surface F4 of the second prism 23 has its second long sides 231 and second short sides 232 oriented along X-axis and Y-axis respectively. Since the second long sides 231 of the second prism 23 are parallel to the first long sides 211 of the biaxially-tilted DMD 21, the incident light A entering the biaxially-tilted DMD 21 along the light path L1 may be regarded as, on the X-Y plane, entering towards the first long sides 211 of the biaxially-tilted DMD 21 as shown in FIG. 3. On the X-Y plane, the incident light A travels along a direction substantially parallel to the Y axis and perpendicular to the X axis when entering the biaxially-tilted DMD 21. The incident light A is then converted into the imaging light B forming an angle of 34 degrees with the Z axis after being reflected by the multiple micro mirrors. The imaging light B proceeds along a light path L2 in the second prism 23, passing through the fourth surface F4 of the second prism 23 before being reflected, could be total internal reflection, by the third surface F3 of the second prism 23. The reflected imaging light B travels in the same medium, the second prism 23, along a light path L3 and at last passes through the fifth surface F5 of the second prism 23 to reach the imaging lens 24 of the projection system 2.

The projection system 2 in the embodiment of the invention makes use of the biaxially-tilted DMD 21 (TRP (Tilt & Roll Pixel) DLP® Pico™ chipset) coming with the second long sides 231 of the second prism 23 made in parallel to the first long sides 211 of the biaxially-tilted DMD 21, that the incident light A entering the biaxially-tilted DMD 21 along the light path L1 may be regarded as, on the X-Y plane, entering towards the first long sides 211 of the biaxially-tilted DMD 21. The deployment of the components in space and design of light paths are made based on the characteristics of the biaxially-tilted DMD 21 in such a way that no redundant included angle between the prism set (a combination of the first prism 22 and the second prism 23) and the digital micro mirrors device will ever exist. Additionally, the illuminating unit 20 is tailored particularly that even though only one aspheric lens is implemented as the (front) first lens set 202 and only one lens is implemented as the (rear) second lens set 203, imaging performance of the projection system 2 may still be maintained. Hence, the component configuration and the light path design may be further improved, which serves well the purpose of reducing the overall size of the projection system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection system with single front lens, comprising:
a light source module for emitting an incident light;
a biaxially-tilted digital micro mirror device (DMD) for receiving and converting the incident light into an imaging light;
a prism set disposed between the light source module and the biaxially-tilted DMD;
a first lens set disposed between the prism set and the light source module and closer to the light source module, for transmitting the incident light, wherein the first lens set consists of an aspheric lens;
a second lens set disposed between the first lens set and the prism set, for transmitting the incident light from the first lens set, wherein the second lens set consists of a lens; and
an imaging lens for receiving and projecting the imaging light.

2. The projection system of claim 1, wherein a refractive index of the aspheric lens of the first lens set is greater than or equal to 1.67.

3. The projection system of claim 1, wherein a ratio of a rear effective focal length for the second lens set to a front effective focal length for the first lens set is greater than or equal to 1.8 and less than or equal to 2.1.

4. The projection system of claim 1, wherein a distance between the first lens set and the second lens set is greater than or equal to 10 mm and less than or equal to 19 mm.

5. The projection system of claim 1, wherein the second lens set consists of an aspheric lens whose refractive index is greater than or equal to 1.48 and less than or equal to 1.75.

6. The projection system of claim 1, wherein the second lens set consists of a spherical lens whose refractive index is greater than or equal to 1.75.

7. The projection system of claim 1, wherein the prism set comprises a first prism and a second prism, wherein:
the first prism comprises a first surface and a second surface neighboring the first surface, the incident light passing through the first surface and the second surface sequentially, and
the second prism, disposed between the first prism and the biaxially-tilted DMD, comprises a third surface, a fourth surface, and a fifth surface, the third surface neighboring the fourth surface and the fifth surface, the fourth surface facing the biaxially-tilted DMD, the incident light sequentially passing through the third surface and the fourth surface to reach the biaxially-tilted DMD and then being converted into the imaging light, the imaging light sequentially passing through the fourth surface and being reflected by the third surface and passing through the fifth surface to reach the imaging lens.

8. The projection system of claim 7, wherein the second lens set stacks with the first prism.

9. The projection system of claim 7, wherein the biaxially-tilted DMD device is in the form of a first rectangle comprising two opposite first long sides and two opposite first short sides, and the fourth surface of the second prism is in the form of a second rectangle comprising two opposite second long sides and two opposite second short sides, the second long sides parallel to the first long sides, the second short sides parallel to the first short sides.

10. The projection system of claim 7, wherein the first lens set is disposed between the first prism and the light source module, and the second lens set is disposed between the first lens set and the first prism, the imaging lens facing the fifth surface of the second prism.

11. The projection system of claim 7, wherein a refractive index of the first prism is less than a refractive index of the second prism.

12. The projection system of claim 7, wherein the second prism is an isosceles right triangle prism and a refractive index of the second prism no greater than or equal to 1.6.

13. The projection system of claim 1, further comprising:
a reflecting module disposed between the first lens set and the second lens set for reflecting the incident light from the first lens set to the second lens set; and
a shading component disposed between the first lens set and the reflecting module.

14. The projection system of claim 1, wherein the projection system is a telecentric projection system.
